(19) United States
(12) Patent Application Publication
(10) Pub. No.: US 2014/0074608 A1
(43) Pub. Date: Mar. 13, 2014

(54) RAPID IDENTIFICATION OF SEARCH TERMS THAT SURGE IN RESPONSE TO CURRENT EVENTS

(71) Applicant: Bridgetree, Inc., Fort Mill, SC (US)

(72) Inventors: Mark Beck, Fort Mill, SC (US); Robin Snyder, Richmond Hill, GA (US)

(73) Assignee: Bridgetree, Inc., Fort Mill, SC (US)

(21) Appl. No.: 14/015,882

(22) Filed: Aug. 30, 2013

Related U.S. Application Data
(60) Provisional application No. 61/695,957, filed on Aug. 31, 2012.
(60) Provisional application No. 61/709,090, filed on Oct. 2, 2012.
(60) Provisional application No. 61/780,937, filed on Mar. 13, 2013.

(51) Int. Cl. G06Q 30/02

(52) U.S. Cl. CPC G06Q 30/0273; G06Q 30/0256
USPC 705/14.54

(57) ABSTRACT

A method has steps of receiving a feed containing words relating to current event; identifying selected ones of the words as being in a category of words relating to the current event; matching the selected ones of the words to an advertising buyer based on a predetermined ad terms for the advertising buyer; and acquiring, in response to the matching, an ad word for the advertising buyer based on the predetermined ad terms for the advertising buyer.

This application claims the benefit of U.S. Provisional Application No. 61/695,957 filed Aug. 31, 2012 for HEADLINE SORT TAIL ADVERTISING PRODUCTION, MEDIA PROCUREMENT AND PLACEMENT SYSTEM, U.S. Provisional Application No. 61/709,090 filed Oct. 2, 2012 for HEADLINE SORT TAIL ADVERTISING PRODUCTION, MEDIA PROCUREMENT AND PLACEMENT SYSTEM, and U.S. Provisional Application No. 61/780,937 filed Mar. 13, 2013 for RAPID IDENTIFICATION OF SEARCH TERMS THAT SURGE IN RESPONSE TO CURRENT EVENTS, all of which are incorporated herein by reference.

### BACKGROUND OF THE INVENTION

1. Field of the Invention

The present invention relates generally to digital advertising, and more specifically to search-based online digital advertising. Even more specifically, the present invention relates to rapid identification and matching of short tail search terms with advertising buyers based on short tail search terms that surge in response to current events.

2. Discussion of the Related Art

Online display and email advertising has two basic pricing methods—Cost per Impression (CPI) or Performance Based Pay per click (PPC). In accordance with CPI advertising, the cost of web-based display advertising or email advertising is paid by an advertiser every time an ad is displayed to a user, customer or potential customer. Typically, buyers of CPI advertising are most interested in having their advertising message seen (such as for building brand recognition). In accordance with PPC advertising, the cost of web-based display advertising or email advertising is paid by an advertising buyer every time an ad is “clicked” by a user, customer or potential customer. (“Clicking” refers to a gesture made by a computer input device, such as a mouse, trackball, touchpad, joystick, graphics tablet, stylus, touchscreen or the like, indicating a desire to open an object, in this case content indicated by an advertisement. The content may include a web page, audio content, video content, an email form or client for sending an email message, an application or “app” on a computer or mobile device, or the like.) Typically, buyers of PPC advertising are most interested in qualified leads that result in a sale. Mass brands tend to rely on CPM (in order put their brand in front as many “eyeballs,” i.e., users, customers, and potential customers as possible) while sale-focused PPC advertising tends to rely on very narrow and specific people who have demonstrated a need.

Well-researched “Long Tail” versus “Short Tail” search terms used in paid search advertising consideration—where a short tail consists of common, frequently used descriptive words (which tend to be shorter, e.g., one word to three words per search) and long tail consists of less used words or phrases (that tend to be longer, e.g., more than three words per search). In general, common short tail words, such as “moving,” tend to be presented by search engine users to search engines more frequently than long tail words, such as “Charlotte North Carolina moving storage packing company,” and therefore advertisements associated with short tail words are more likely to be displayed to more users searching for certain types of information, services or products. As a result, short tail search terms attract more advertising buyer interest, and, as a result, advertising sellers tend to charge more money for advertisements associated with short tail search terms than those associated with long tail search terms. Advertising buyers seek long tail words because they may be less discovered and therefore will be a less expensive way to secure a lead.

### SUMMARY OF THE INVENTION

Several embodiments of the invention advantageously address the needs above as well as other needs by providing a system and method for search-based digital advertising.

In one embodiment, the invention can be characterized as a method having steps of receiving a feed containing words relating to current event; identifying selected ones of the words as being in a category of words relating to the current event; matching the selected ones of the words to an advertising buyer based on a predetermined ad terms for the advertising buyer; and acquiring, in response to the matching, an ad word for the advertising buyer based on the predetermined ad terms for the advertising buyer.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a block diagram showing an overview of a system and method for search based digital advertising in accordance with one embodiment of the present invention.

FIG. 2 is a block diagram of a headline aggregator system in accordance with one variation of the embodiment of FIG. 1.

FIG. 3 is a detailed block diagram of an embodiment of the headline aggregator system of the variation of FIG. 2.

FIG. 4 is a block diagram of an advertiser collection system in accordance with a variation of the embodiment of FIG. 1.

FIG. 5 is a block diagram of an advertiser collection system in accordance with an additional variation of the embodiment of FIG. 1.

FIG. 6 is a block diagram of a contextualization process in accordance with an additional variation of the embodiment of FIG. 1.

FIG. 7 is a block diagram of a reputation and quality check process in accordance with another variation of the embodiment of FIG. 1.

FIG. 8 is a block diagram of a campaign results database in accordance with a further additional variation of the embodiment of FIG. 1.

FIG. 9 is a block diagram of a match advertisers to bid terms with landing page process in accordance with another additional variation of the embodiment of FIG. 1.

FIG. 10 is a block diagram of an advertisement auction and bidding process in accordance with yet a further variation of the embodiment of FIG. 1.

FIG. 11 is a flow diagram showing an overview of a method for search based digital advertising in accordance with one embodiment of the present invention.

Corresponding reference characters indicate corresponding components throughout the several views of the drawings. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

Existing research and paid search heuristics ignore a category of short tail search terms because such short tail search terms appear and disappear suddenly, e.g., short tail search terms from breaking news stories and trending topics from, for example, social networks and Twitter, which quickly become the topic of searches and then quickly cease to be the topic of searches. Because of a lack of search history associated with this category of short tail search terms (short tail search terms associated with a breaking news story or with a trending topic on social networks or Twitter, may have little, if any, prior search history) and because heretofore there has been a lack of a fast, reactive system that can produce and place relevant paid search advertising messages quickly, search terms in this category of short tail search terms often attract no competitive advertising buyer bidders in a timely manner, which means that a paid-search advertisement based on short tail search terms in this category will be very low cost (for a period of time) relative to a paid-search advertisement based on short tail search terms not in this category.

Audiences attract advertisers as their members constitute prospects (customers or potential customers) for the advertiser's products or services. Finding an audience in a size and location that can be advertised to in a manner affordable to an advertising buyer is in great demand by advertising buyers. Users searching for search terms in the category of short tail search terms that appear and disappear suddenly, as described hereinabove, together represent just such an audience, i.e., an audience that can be of a size and location that can be affordable to advertise to (because such audience is reached through the category of short tail search terms that have, for a period of time, attracted little or no competitive advertising buyer bidders).

The present invention, in accordance with some embodiments, is a method that identifies short tail search terms that appear and disappear suddenly, such as from breaking news stories and trending topics, and thus represent sudden surges of audiences based on breaking news stories or trending topics from social networks and Twitter, and a reactive system that determines contextual relevance of search terms from breaking news stories and trending topics, and rapidly executes advertising purchased based on the category of short tail search terms, allowing the advertising buyer to capitalize (place advertising messages) on the category of short tail keywords before a search history for such search terms develops and competitive advertising buyer bidders begin to drive the cost of such short tail search terms up to a higher cost. As such, the advertising buyer is able to place advertisements with advertising sellers for paid-search advertisement based on short tail search terms for a very low cost, as heretofore known methods and systems cannot identify the search terms within the category of short tail search terms quickly enough, i.e., prior to the development of the history for such search terms, and the driving of the cost of such short tail search terms to the higher cost.

Any advertising buyer can purchase advertising associated with short tail search terms of the category of short tail keywords, e.g., of breaking news stories or trending topics, using manual methods (creating an ad, creating a landing page, etc.). However, while an advertising buyer may be able to do this in a limited way, automation that comes from multiple database content, advertising components and history can scale and sustain an ongoing audience surge advertising effort that can outpace search term history development in significantly, and thereby enable paid-search advertisement based on short tail search terms for a very low cost, as described herein.

Paid-search advertisement pricing is based on advertising buyer demand as driven by search term history—the more search terms, i.e., words or phrases, are used by users, customers and potential customers (advertising consumers), the more advertising buyers try to buy an advertisement placement based on such search terms, i.e., words or phrases, the higher the cost per click (PPC)charged by the advertising seller. Some search terms can be very expensive, for example “auto insurance prices” can have a cost per click of more than, for example, $50.00 or more. Words that attract no advertising buyer demand sell for as little as, for example, $0.05 per click. For the advertising buyer who wants to promote to a large audience, search terms within the category are very attractive because they attract a large number of viewers, have context (can segment the consumers by their interest in, e.g., the particular breaking news story or trending topic subject) and are very low cost because the advertising buyer indicated demand as indicated by search term history is often very low or none, and the advertising buyer demand, as driven by search term history, does not reflect a much higher advertising buyer actual demand, because advertising buyers are not able to react fast enough to take advantage of the sudden audience surges based, for example, on breaking news stories or trending topics.

The present invention, in accordance with some embodiments, is a system and method that rapidly identifies, contextualizes, assembles and executes advertising in response to very sudden audience surges associated with breaking news stories and/or trending topics. The system has several components that come together to create a system that allows an advertising buyer to effectively and consistently identify search terms in the category.

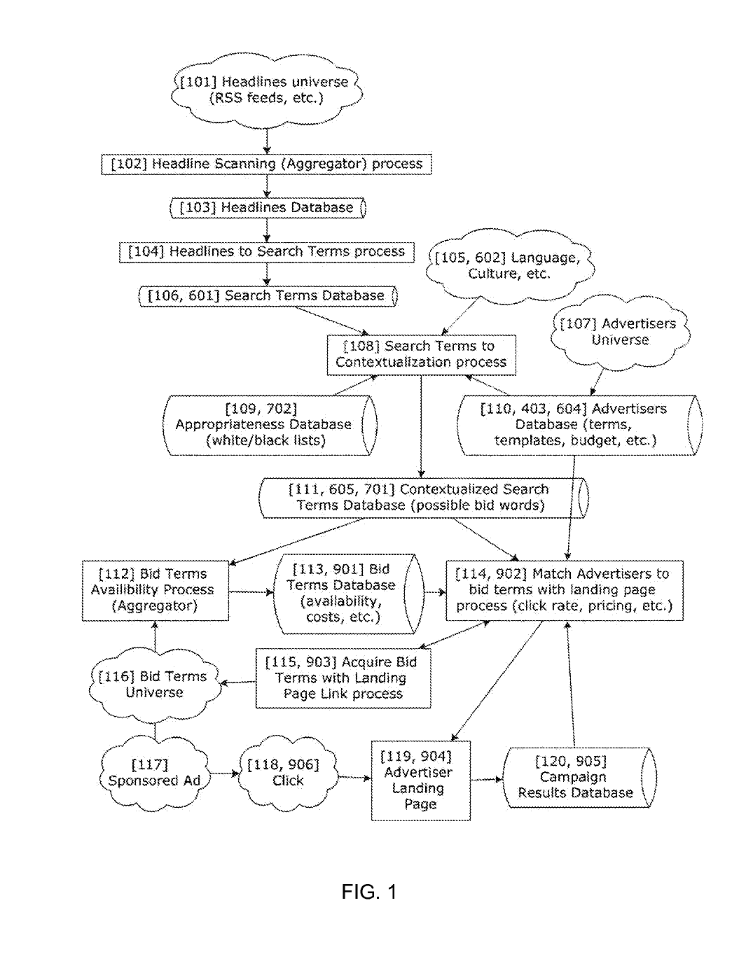

Referring to FIG. 1, a block diagram is shown of one embodiment of the present invention. The system acquires breaking news stories or trending topics from social networks and/or Twitter in a timely manner, such as by monitoring an RSS feed, and matches search terms in the category to advertising buyers such that advertisement placement (sponsored ads) associated with the search terms in the category can be obtained quickly to direct potential customers to the advertising buyer's content, e.g., a landing page or other web page generated by the system or by the advertising buyer, audio content, video content, an email form or client for sending an email message, an application or “app” on a computer or mobile device, or the like.

Shown is a Headline universe, a Headline scanning (aggregator) process, a Headlines Database, a Headlines to Search Term process, a Search Terms Database, language, cultural, etc. factors, a Search Terms to Contextualization process, an Appropriateness Database, an Advertiser's Database, an Advertiser's Universe, a Contextualized Search Terms Database, a Bid Terms Availability process (Aggregator), a Bid Terms Database, a Match Advertisers to bid terms with landing page process, a Bid Terms Universe, an Acquired bid terms with landing page link process, a sponsored ad, a click, an Advertiser Landing Page, and a Campaign Results Database.

The Headlines universe consists of sources of headlines, or, breaking news, or trending topics, such as RSS feeds. The Headlines universe is examined by the Headline Scanning (Aggregator) process. The Headline Scanning process feeds headlines discovered through the process to the Headlines Database, and the Headlines to Search Terms process identifies search terms from the Headlines Database. The Headlines to Search Terms process outputs search terms to the Search Terms Database. Using input from the language, culture, etc., the Search Terms to Contextualization process takes the Search Terms Database, the Appropriateness Database, and the Advertisers Database and generates contextualized search terms therefrom, and outputs these contextualized search terms to the Contextualized Search Terms Database. The Advertisers Database is generated from the Advertisers Universe. A contextualized search terms database is output to the bid terms availability process and to the match advertisers to bid terms with landing page process. The bid terms availability process reads the bid terms universe and outputs available bid terms to the bid terms database. The bid terms database is also read by the match advertisers to bid terms with landing page process. The match advertisers to bid terms with landing page process also reads the advertisers database and the campaign results database, and outputs the match results to an acquired bid terms with landing page link process. The acquired bid terms are then linked with sponsored ads that are displayed to users, and are available for clicking by the user. Once the user clicks on the sponsored ad, the advertiser landing page, for example, is displayed and analytics are recorded. The analytics are output to the campaign results database which is fed back to the match advertisers to bid terms with landing page process. Similarly, the match advertisers to bid terms with landing page process outputs to the advertiser landing page.

The Headlines universe [101] consists of headlines such as those found in RSS feeds that include news sites, Twitter feeds, etc.

The Search Terms Database [106, 601] contains search terms relevant to the invention.

The Advertisers Universe [107] contains all relevant information about advertisers and is maintained in the Advertisers Database [110, 403, 604], which includes possible ad terms, templates, budget, preferences, etc.

A Sponsored Ad [117] is an ad that appears on a search page results page and are available from many sources (e.g., Google, Bing, etc.).

The Advertiser Landing Page [119, 904] is the page to which users are taken when a Click [118, 906] is made on a Sponsored Ad [117].

The Campaign Results Database [120, 905] contains the results of a Click [118, 906] on the Sponsored Ad [117] that results in following a link to the Advertiser Landing Page [119, 904]. The Campaign Results Database may also store conversion rates, which is the proportion of visitors to a website who take action to go beyond a casual content view or website visit. For example, conversion rate may relate to the number of visitors who made an account, viewed a product, made a purchase, clicked on a link, filed a filed etc. on the website.

The headlines are acquired by the Headline Scanning [102] and suitably placed into the Headlines Database [103].

The Headlines to Search Terms process [104] takes the aggregated headlines from the Headlines Database [103] and converts them into possible search terms which are placed into the Search Terms Database [106, 601].

The Search Terms to Contextualization process [108] takes information from the Advertisers Database [110, 403, 604], concepts of language, culture, etc., in the Language, Culture, etc. [105, 602], and suitability/unsuitability from the Appropriateness Database [109, 702] to obtain the Contextualized Search Terms Database [111, 605, 701]. Headlines search terms, and information in the Advertisers Database may be contextualized use natural language processing methods such as Dirichlet allocation (LDA) and latent semantic indexing (LSI).

The Match Advertisers to bid terms with landing page process [114, 902] takes information from the Advertisers Database [110, 403, 604], contextualized search terms (possible bid words) from the Contextualized Search Terms Database [111, 605, 701], and available and cost-satisfactory bid terms from the Bid Terms Database [113, 901], acquires the bid terms from the Acquire Bid Terms with Landing Page Link process [115, 903] and creates the desired Advertiser Landing Page [119, 904].

From the Bid Terms Universe [116], the Bid Terms Availability Process [112] uses the Contextualized Search Terms Database [111, 605, 701] to aggregate and place bid terms with availability, costs, etc. into the Bid Terms Database [113, 901].

Headline (breaking news) can occur on the web through news aggregators such as Huffington Post or Drudge, traditional electronic or paper news sites (e.g. Washington Post), search trending indicators, event lists and completion times (sports events are preplanned—but the outcomes become a headline), radio talk shows and cable and network news. The headline scanning system monitors breaking news and events through web crawlers and manual effort and matches them into advertising product or service topical context and geographic areas.

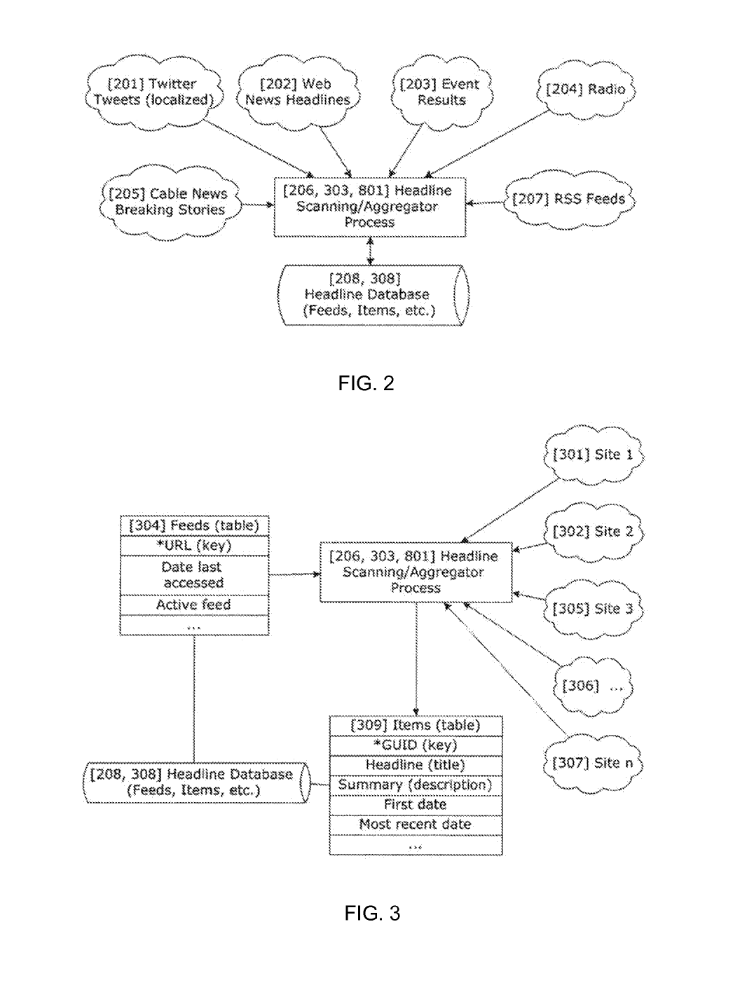

Referring next to FIG. 2., a block diagram is shown of the Headline Scanning (Aggregator) process of FIG. 1 in accordance with one variation of the embodiment of FIG. 1. Headlines can come from many places such as cable news, web news, radio, etc. In accordance with the present embodiment, an RSS feed (Really Simple Syndication feed) is described as a source of headlines. Where an RSS feed does not exist for the desired headlines and summaries, other methods are used to obtain the headline and summary in text form for use in the system.

Shown are cable news breaking stories, a Twitter feed, Web news headlines, event results, radio, and other RSS feeds. Also shown is a headline scanning (aggregator) process, and a headline data base.

Twitter Tweets are one source of timely headlines from tweets of followed Twitter users. Twitter feeds can usually be obtained as RSS feeds.

Web News Headlines are another source of headlines from the web pages of web news sites, and can often be obtained as RSS feeds.

Traditional broadcast Radio is a source of headlines from the audio-to-text translation of the radio station.

Other RSS Feeds are a further source of headlines from the content of the feeds. These RSS feeds may be generated by blogs, social networks or the like.

Cable New breaking stories, event results and the like also generate RSS feeds that can be utilized by the present embodiment (aggregator) system. One aspect of the present embodiment is the Headline Scanning (Aggregator) Process. The Headline Scanning (Aggregator) Process obtains headlines from sources such as Cable News Breaking Stories, Web News Headlines, Event Results, Radio, other RSS Feeds, Twitter feeds, etc., and updates them in a suitable form (such as in an RSS feed) to the Headlines Database.

Referring next to FIG. 3, a specific example of the Headline Scanning (Aggregator) system in accordance with the variation of FIG. 2 is shown.

Shown is a plurality of sites providing, for example, RSS feeds to a headline scanning (aggregator) process. The headline scanning (aggregator) process categorizes headlines and stores the categorized headlines into the headline database. A feed table provides information to the headline scanning (aggregator) process regarding the sites.

The Headline Scanning (Aggregator) Process obtains headlines (e.g., via RSS feeds) from Site 1, Site 2, . . . , Site n, and updates the Headline Database, primarily by updating the Feeds table and Items table.

Two examples of ways in which the Headline Scanning (Aggregator) Process categorized headlines are as follows:

1. Each headline is tokenized into a normalized sequence of symbols. Normalization is used to include/omit punctuation, group words, etc. For each headline in an RSS feed, perform a LOS (Longest Common Subsequence) algorithm (e.g., Hirschberg's algorithm from 1974) is performed of the headline with all other possible matching headlines (i.e., with at least one matching symbol). A table of aliases allows matching of words that are equated in the table of aliases. Any sequence of these words or greater in a headline is considered a possibility for a long tail search term.

2. A machine learning algorithm can be used to categorize words found in headlines into search terms. A machine learning algorithm requires some history of patterns with which to make decisions so past history and decisions are stored in an appropriate database to support the machine learning algorithm.

The headline aggregator system is described in terms of using RSS feeds but is not limited to RSS feeds. Where an RSS feed does not exist for the desired headlines and summaries, other methods are used to obtain the headline and summary in text form for use in the system.

In general, an RSS (Really Simple Syndication) feed provides a fairly standard way to obtain headlines and a few sentences of content on such headlines in a text form, and a link to full content. The RSS feed is provided by a creator or provider of the content. The RSS feed follows an XML (Extensible Markup Language) format that might appear as follows in a general example (with text used instead of actual links dates, etc.).

```
    <?xml version=“1.0”>
    <rss version=“2.0”>
    <channel>
        <title>News headlines</title>
        <description>Current news
headlines</description>
        <link>link to the news headlines</link>
        <item>
            <title>Headline #1</title>
            <description>Summary of headline
#1</description>
            <link>link to this item</link>
            <guid>unique id for this headline</guid>
            <pubDate>pub date of this item</pubDate>
            </item>
        <!-- ... and so on for each headline -->
        </channel>
    </rss>
```

The Headline Scanning (Aggregator) Process receives the RSS feeds and, at periodic intervals, polls the RSS feeds for updated content. The content provided in a RSS feed consists of items where each item has a title (e.g., headline), description (e.g., summary), and a link to more detail on that item. These items are stored in a headline item table with, in addition, the id of the feed in the RSS feeds table and the date and time that the item was first added and most recently appeared in the feed.

The Headline aggregator may use various natural language processing techniques to parse the content and categorize similar news items by topics and/or news events. Using statistical analysis, a computer can compare word adjacency frequency and use the frequency information to predict whether a word in the document has similar meaning to a word in another document without the computer reading or understanding what the words mean. Natural language processing may include methods such as Dirichlet allocation (LDA) and latent semantic indexing (LSI)

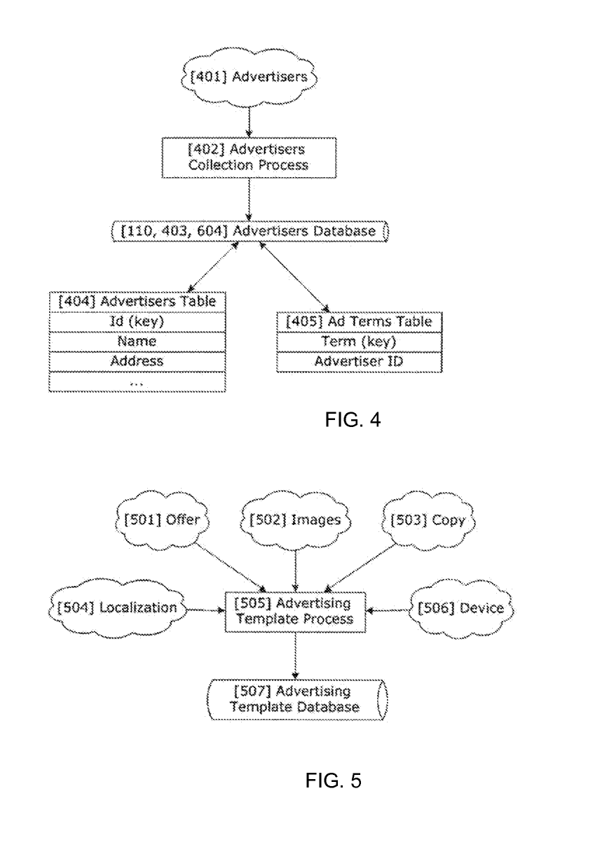

Referring next to FIG. 4 an Advertiser Collection System is shown in accordance with one variation of the embodiment of FIG. 1 collects information from advertisers and updates the advertiser database.

Shown are advertisers that are processed by an advertisers collection process and placed into an advertisers database. The advertisers database comprises an advertisers table that provides information on each advertiser, and an ad terms table that identifies search terms important to each advertising buyer.

Advertisers represent a universe of all possible advertisers.

An Advertisers Database is a database of advertising buyers. The primary parts of Advertisers Database are an Advertisers Table and an Ad Terms Table.

An Advertisers Table is a table in the Advertisers Database that contains advertising buyer names, addresses, etc.

An Ad Terms Table is a table in the Advertisers Database that contains search terms important to each advertising buyer.

An Advertisers Collection Process collects information from advertising buyers, as a combination of manual and automated methods, to update the Advertisers Database whose primary tables are the Advertisers Table and the Ad Terms Table.

Referring next to FIG. 5, an Advertising Template System in accordance with another variation of the embodiment of FIG. 1 is shown.

Shown are sources, including localization, author, images, copy, and device. Also shown is the advertising template process, and the advertising template database.

The Advertising Template Database contains information about advertising buyers and search terms that target the interests of the advertising buyers.

The Advertising Template Process obtains advertising template information from sources such as Localization, Offer, Images, Copy, Device, etc., and updates the Advertising Template Database.

Advertising template information is obtained from sources such as Localization [504], Offer [501], Images [502], Copy [503], Device [506], etc., and updates the Advertising Template Database [507].

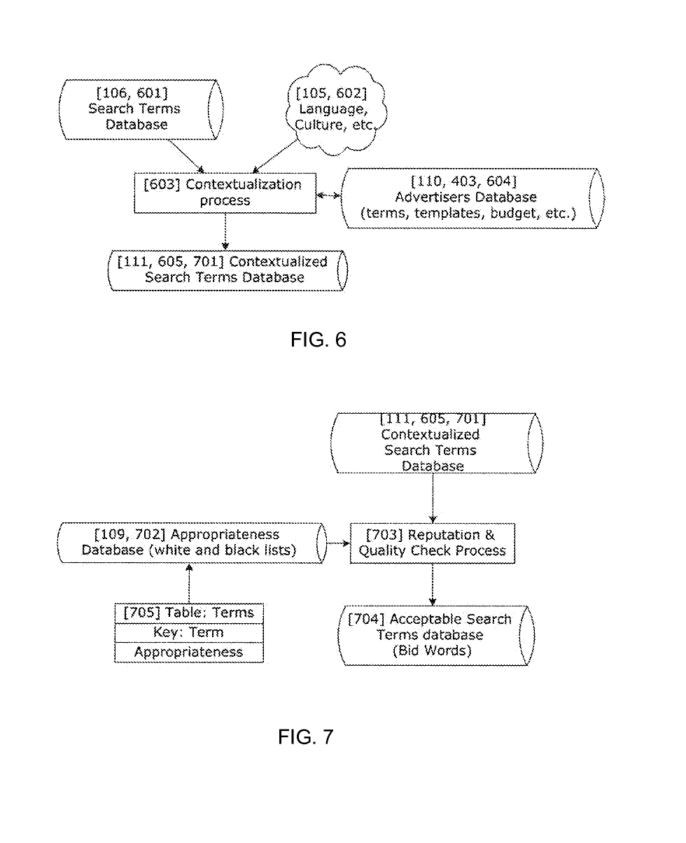

Referring to FIG. 6, a Contextualization Process is shown in accordance with yet another variation of the embodiment shown in FIG. 1. The contextualization process receives concepts from Language, Culture, etc., information from the Search Terms Database, and information from the Advertisers Database and updates the Contextualized Search Terms Database.

Shown are the concepts from language, culture, etc., and the search terms database, which provide inputs to the contextualization process. In addition the advertisers database provides an input to the contextualization process, as well as an output. The contextualization process also outputs to the contextualized search terms database.

The Search Terms Database contains possible search terms for the Contextualization process.

The Language, Culture, etc. is the universe of language, culture, etc.

The Advertisers Database contains information such as terms, templates, budget, etc., for advertising buyers.

Contextualization is a process of adding relevant content to the search terms in the search terms database in order to provide context to the search subject. Contextualization Process uses a set of algorithms to convert the headlines to search terms. This is done from the Search Terms Database, Language, Culture, etc., appropriateness database (e.g., white and black lists), and the advertisers database (terms, templates, budget, etc.).

Referring next to FIG. 7, a Reputation and Quality Check process is shown in accordance with a variation of the embodiment of FIG. 1. The Reputation and Quality Check process takes information from the Contextualized Search Terms Database and terms from the Appropriateness Database and updates the Acceptable Search Terms database.

The Contextualized Search Terms Database [111, 605, 701] contains contextualized search terms.

The Appropriateness Database [109, 702] contains appropriate and inappropriate lists of search terms (i.e., white and black lists) for use by a Reputation & Quality Check Process.

The Appropriateness Database is structured with a table of terms, each with an indication of when the term is appropriate or inappropriate.

The Reputation & Quality Check Process takes information from the Contextualized Search Terms Database and from the Appropriateness Database and creates and/or updates the Acceptable Search Terms database by filtering out unacceptable search terms. The Acceptable Search Terms database can be human reviewed for reputation risk management (to reduce the possibility of an inappropriate term or topic being applied).

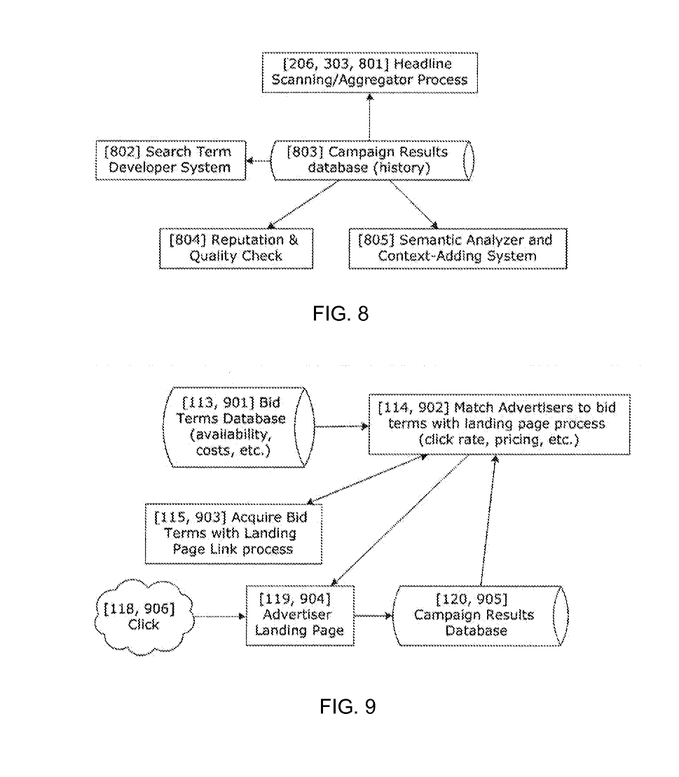

Referring next to FIG. 8, shown is a Campaign Results Database in accordance with an additional variation of the embodiment of FIG. 1

The Campaign Results database contains the results and history of clicks by advertising consumers.

The Search Term Developer System uses the Campaign Results database.

The Reputation & Quality Check uses the Campaign Results database.

The Semantic Analyzer and Context-Adding System uses the Campaign Results database.

This system will keep a headlines paid search history database of past terms used and results to use as a basis for phrase automation (a system that automatically generates terms) and prediction (a system that predicts audience size, click-through and costs). The completed process will result in a list of acceptable search “bid words” on which to place advertising and which are loaded into an order for paid search advertising.

Results such as campaign history; searches by time, by search words, click-through, activations, costs, etc., will be loaded into a campaign results database as a historical basis for future estimates and campaign improvement rules and practices. This connects to the audience, cost predictors and creative message analytics.

The Campaign Results Database contains the results of a Click on a sponsored ads on the Advertiser Landing Page.

The Match Advertisers to bid terms with landing page process takes information from the advertisers database, contextualized search terms (possible bid words) from the bid terms database, and available and cost-satisfactory bid terms from the Bid Terms Database and acquires the bid terms and creates the desired Advertiser Landing Page.

Using a database of advertising copy, advertising formats and advertising images (pictures and logo's) and devices (mobile, pad, pc, etc.), and localization (local stores, dealer, agent, representatives, contacts) advertising is automatically assembled and contextualizing is applied to fit the headline topic so that the advertising is relevant to the headline.

The web landing page is the page to which the advertisement transfers the customer when the customer clicks the advertisement link. Tested, web landing page web site (URL's, sign up, copy area, pictures, offer, fraud prevention and detection, frames, etc.) components will be held in web landing page template databases for automated component assembly. Upon assembly and quality check, the landing page will automatically publish to a production server that is rated/scaled to meet the predicted click-through demand. During this process, the landing page URL will be embedded in the paid search advertising component.

The Database of Desirable Search Phrases with Price Willing to Pay contains search terms and the price for which someone such as an advertiser is willing to pay for those search terms.

The Search Phrase Auction auctions bid terms such that the winner of the bid has their advertisements appear in search result pages with links to the advertiser's landing page to which the user is taken when the link is clicked on the search result page. The actual workings of auctions are complex and are external to the system being described.

The Bid Result Decision is that the bid was won or the bid was lost by the Bidder Process [1004].

The result of Bid Won is that advertisements start appearing on search result pages that are displayed in response to search terms entered by the user.

The History Database contains the results of both Bid Won and Bid Lost.

The result of Bid Lost is that no advertisements appear on pages that are displayed in response to search terms entered by the user and bid on by the Bidder Process.

The topics will be estimated by audience size and duration. These estimates will be built using tools that connect to a database of audience size and duration, click-through and click pricing. These elements will combine to create a campaign estimate for cost and click response by total and time period. This information will be used for budgeting and loaded as bid parameters in the paid search order.

FIG. 11 is a flow diagram of an overall process for identifying advertisement search terms in accordance to some embodiments. In step 1101, news items are collected. New items may refer to various sources of information relating to current events. For example, news items may include news headlines and articles, RSS feeds, social media update (such as Twitter, Facebook), blog posts, stock tickers, weather reports, calendars of scheduled events etc. News items may be gathered through monitoring websites, feeds, news services, radio and/or television channels, emergency alter systems, etc. In some embodiments, a filtering step is applied within step 1101. With a filtering step, only items meeting certain criteria are stored in the collection for analysis in step 1103. For example, news items may be filtered by source, author, date, content, language, geographical location etc. Examples of a news item or headline scanner/aggregator according to some embodiments are described with reference to FIGS. 2-3 above.

In step 1103, news items collected in step 1101 are analyzed for information. Step 1103 may use various natural language processing techniques to parse the content and categorize similar news items by topics and/or news events. Using statistical analysis, a computer can compare word adjacency frequency and use the frequency information to predict whether a word in the document has similar meaning to a word in another document without the computer reading or understanding what the words mean.

In some embodiments, latent semantic indexing (LSI) is performed on the collection of news items. LSI is an indexing method that uses mathematical technique to identify patterns in the relationships between terms and concepts contained in an unstructured collection of text. LSI can be used to perform automated document categorization based on the similarity of the conceptual content of the categories and/or to other documents within the collection. With LSI, new items may be categorized according to the events they cover based on LSI analysis.

In some embodiments, the collection of new items may be analyzed with latent Dirichlet allocation (LDA). LDA is a generative model for topic modeling that is a type of hieratical Bayesian model. In LDA, each document may be viewed as a mixture of various topics and each word in the document is attributable to at least one of the document's topics. Topics are identified on the basis of supervised labeling and pruning on the basis of their likelihood of co-occurrence. In some embodiments, the topics are identified based on the information in the contextualization process as described with reference to FIG. 6 above. A word may occur in several topics with a different probability, but with a different typical set of neighboring words in each topic. By analyzing the combination of words in a document, LDA can classify a document by the topics identified within the document. Thus, news events covered by the new items can be identified based on LDA analysis. LDA is generally more amendable to customization such as grouping by dates and location.

Additionally, using Dirchilet, Bayesian and other methods, a computer can calculate the probabilities that words (occurrences) will be grouped into topics (groups of occurrences). With this approach, the computer can process the items of news without a set of training documents to establish the topics for analysis.

In step 1105, breaking news events are identified based on the analysis in step 1103. After the news items are categorized and grouped in step 1103, the result of the analysis is may be compared to historical data to determine whether new categories/topics have emerged. An emergence of a new category/topic may be an indication of a breaking news event. For example, if a grouping of words and phrases that had not been common in the previous time period suddenly occurs in multiple new items, the prominence of new grouping of words and/or phrase may signal a breaking news event. In some embodiments, historical data of a combination of words and/or phrases is used as a baseline for comparison. A sudden increase in frequency of identified topic/category as compared to the baseline may indicate a breaking news event. It is noted that the computer processing the news items need not necessarily identify the breaking news event by name or description in step 1105. Rather, the identification of a breaking news event may simply include the identification of an emergence of a trend in the collected news items and/or a grouping of the associated news items.

In step 1107, search terms are generated based on identified breaking news events in step 1105. In some embodiments, keywords and phrases that lead to the categorization of the news items in step 1103 can be used to form search terms in step 1105. In some embodiments, news items associated with the breaking news events is analyzed to determine a set of keywords/phrases that are relevant to the news event. Search terms may be generated based on combination of relevant words or phrases.

In some embodiments, step 1107 may include contextualization process and appropriateness filtering. Examples of contextualization process and appropriateness filtering are described with reference to FIGS. 6-7 above. In some embodiments, search terms are formed based on advertiser information and/or advertiser provided terms database as described with reference to FIGS. 1 and 4 above. In some embodiments, advertiser provided terms are assigned to breaking news categories/topics. When a breaking news category/topic is identified, the advertiser provided terms are used as search terms. In some embodiments, step 1107 may also take into consideration the rules and restriction of a particular advertisement service, such as Google AdWords and AdSense.

In some embodiments, different combinations of search terms may be analyzed using to determine their relevancy to a potential advertiser's product and/or the breaking new events. For example, a preliminary web search may be performed and the returned search result may be used to determine the relevancy of the search keywords to the potential advertiser's product and/or the breaking new events. For example, the number of top search results that are relevant to the potential advertiser's product and/or the breaking new events may be counted and used to determine the quality of the search term. In some embodiments, Google's search suggestions API may is used to determine the relevancy of a combination of search keywords. In some embodiments, campaign results as described with reference to FIG. 8 above is used as a learning tool to adjust the selection of search terms. For example, search keyword combinations similar to those keywords that had historically produced good results (e.g. high click-through and/or conversion rates) may be preferred over others.

In some embodiments, a number of search terms combinations may be generated from one or more breaking news events. These terms may be grouped based on advertiser interests such as product/service types, geographical regions, targeted demographic etc. In some embodiments, the generated search phrases are ranked based on their quality and cost ratio. The quality of a search phrase may be based on its relevancy to the news event and/or an advertiser's interest and other factors. The cost of the search terms may be estimated by querying the API of an advertisement service, such as Google AdWords and AdSense. For example, the advertisement service may be queried to determine the highest bid amount that had been submitted for the search terms. In some embodiments, search terms may be assigned a score based on its quality and cost ratio. In some embodiments, only search keywords meeting a quality and cost ratio score threshold is passed onto step 1109.

In step 1109 the identified search keywords are matched with potential advertisers. One example of the matching process is described with reference to FIG. 9 above. A similar process may also be performed based on other types of data provided by the advertiser in place or in additional to the information on the advertiser landing page described in FIG. 9. For example, an advertiser may provide a list of keywords that may be relevant to their product/service or targeted audience but does not appear on their landing page. An advertiser may also only be interested in a select demographic and/or geographical region. Advertisers may also specify cost limitations on search keyword bids. Such information and other information related to the advertisers may be stored in an advertiser collection system. An example of advertiser collection system is described with reference to FIG. 4 above. Search terms identified in step 1107 may be compared with the information in the advertiser collection system to match advertisers to terms keywords. The information in the advertiser collection system may be utilized in steps 1107, 1109, and/or step 1111.

In some embodiments, search keywords are scored and ranked for specific advertisers similar to what is described with reference to step 1107. For example, search keywords are analyzed for its relevancy to a specific advertiser's interest, products, desired demographic, etc., and only search terms meeting a threshold quality and cost ratio is passed onto step 111. In some embodiments, advertiser approval is required prior proceeding to step 1111. In other embodiments, the process is automated once the appropriate information is entered.

While in FIG. 1, step 1109 follows step 1107, in some embodiments, these two steps may be reversed in order or carried out concurrently. For example, advertisers may be identified based on the identified news event in 1105, and prior to the search terms are generated in step 1107. In such embodiments, an advertiser's specific needs and requirements are taken into consideration when search terms are generated.

In step 1111, advertisement content is generated. In some embodiments, advertisement content is based on advertising template system as describe with reference to FIG. 5 above. In some embodiments, the advertisement content is static. In some embodiments, the advertisement content may be customized according to the search terms, date, geographic region, etc. In some embodiments, the advertisement content is generated to maximize the quality score for an advertising service. For example, Google AdWord scores advertisements based on factors including keyword/search relevance, keyword/ad relevance, targeted devices, etc. The quality score of a submitted advertisement as determined by the advertisement service affects the bid's ranking and the amount of cost per click. In some embodiments, advertiser approval is required prior to proceeding to step 1112. In other embodiments, the process is automated once the appropriate information is entered.

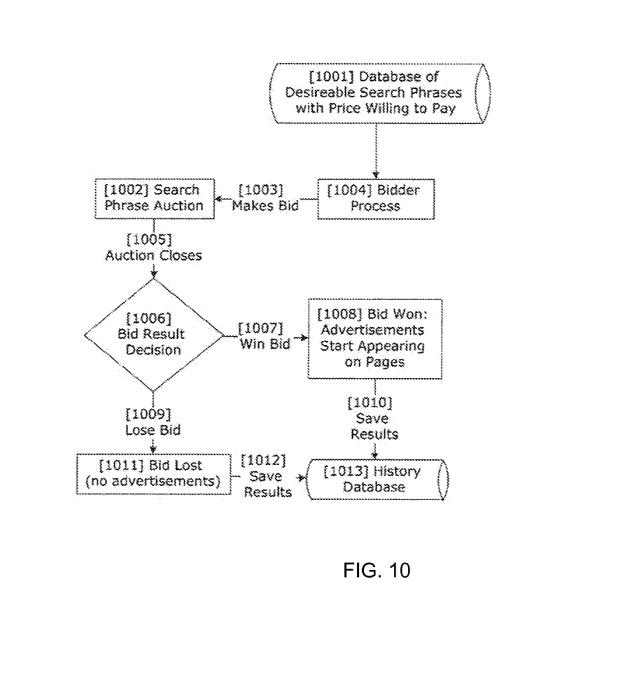

In step 1112, advertisement bid is submitted to an advertisement service. One example of the bid placing process is described with reference to FIG. 10 above. In some embodiments, a listing of generated search terms is provided to potential advertisers, and the advertisers perform at least one of steps 1111 and 1112 manually. The listing of generated search terms may include estimated cost and/or quality score of the search terms.

After step 1112, the system may continue to monitor the success of the bid, the click-through rate of the advertisement, and the conversion rate of an advertisement campaign. This information may be stored in a campaign results database. A campaign results database according to some embodiments is described with reference to FIG. 8 above. The stored campaign result may be used in at least steps 1107 and 1109 above to improve the success of generated search terms for the advertisers. In some embodiments, the campaign results database also stores historical search volume data of the search terms used in the campaign. For example, historical search volume data may be obtained from a search engine's published data, such as Google Trends. The historical search volume data may be use to determine if the prediction of a surge in search terms volume is accurate.

While the invention herein disclosed has been described by means of specific embodiments, examples and applications thereof, numerous modifications and variations could be made thereto by those skilled in the art without departing from the scope of the invention set forth in the claims.

What is claimed is:

1. A method comprising:
receiving a plurality of news items relating to current event;
identifying a emergence of a breaking news events;
identifying search terms relevant to the breaking news event;
matching the search terms an advertising buyer based on a information associated with the advertising buyer; and
submitting, in response to the matching, a bid to an advertising service for the advertising buyer based on the search terms.
